(19) United States
(12) Patent Application Publication
(10) Pub. No.: US 2013/0337357 A1
(43) Pub. Date: Dec. 19, 2013

(54) CURRENT COLLECTING PLATE PIERCED WITH HORIZONTAL HOLES, INTENDED FOR A FUEL CELL

(71) Applicants: Xavier Glipa, Verneuil Sur Seine (FR); Francis Roy, Les Ulis (FR); Eric Pinton, Echirolles (FR); Pascal Schott, Villard De Lans (FR); Sylvie Begot, Chaux (FR); Fabien Harel, Giromagny (FR); Jean-Marc Le Canut, Belfort (FR)

(72) Inventors: Xavier Glipa, Verneuil Sur Seine (FR); Francis Roy, Les Ulis (FR); Eric Pinton, Echirolles (FR); Pascal Schott, Villard De Lans (FR); Sylvie Begot, Chaux (FR); Fabien Harel, Giromagny (FR); Jean-Marc Le Canut, Belfort (FR)

(73) Assignees: Commissariat A L'Energie Atomique Et Aux Energies Alternatives, Paris (FR); PEUGEOT CITROEN AUTOMOBILES S.A., Velizy Villacoublay (FR)

(21) Appl. No.: 13/981,572

(22) PCT Filed: Feb. 1, 2012
(86) PCT No.: PCT/FR2012/050223

§ 371 Date: Aug. 21, 2013

(30) Foreign Application Priority Data
Feb. 2, 2011 (FR) 11 50 827

(51) Int. Cl. H01M 8/02

(52) U.S. Cl. CPC H01M 8/0247
USPC 429/452; 429/517; 429/535

(57) ABSTRACT

The invention relates to a current collecting plate (50) for a fuel cell. According to the invention, the plate comprises a substantially constant thickness of an electrically conductive material along the stacking axis of the cells of the fuel cell, forming a plane at the end of the stack in order to collect the current from the fuel cell. The invention is characterised in that it comprises holes (52) pierced in the thickness of the material, extending parallel to the plane of the plate.

### CROSS-REFERENCE TO RELATED APPLICATIONS

This application is the US National Stage under 35 U.S.C. §371 of International Application Number PCT/FR2012/050223 filed on Feb. 1, 2012 which claims priority to French Application No. 1150827 which was filed on Feb. 2, 2011.

### SUMMARY

The present invention relates to a current collecting plate for a fuel cell that generates electricity and it also relates to a process for calculating this current collecting plate, to a fuel cell equipped with such collecting plates, and to an automobile vehicle and an electricity-generating group comprised of this fuel cell.

Fuel cells are developed today in particular for equipping vehicles as a replacement for internal combustion engines and they permit obtaining a better yield of energy than that of internal combustion engines by producing electricity used by an electrical traction machine.

Fuel cells generally comprise a stack of elementary cells each comprising two electrodes separated by an electrolyte, and conductive plates that supply the fuel and the oxidizer to the electrodes by internal conduits. The electrochemical reactions that take place upon contact with the electrodes generate an electric current and produce water while releasing heat energy that heats the different components.

In order to function correctly the fuel cells must be at a certain temperature range, depending on the type, between 20 and 800° C. The heat released by the starting of the reactions when the cell is cold serves, at first, to heat the cells in order bring them to the desired operating temperature. Then, a circuit of heat-conveying fluid regulates this temperature.

A problem that is posed in the case of starting a fuel cell with a low temperature that is less than 0° C. is that the water produced by the electrochemical reactions is at risk of freezing as long as this temperature is below this threshold of 0° C. The fuel cell can no longer function correctly then and risks being destroyed.

The stack of cells is generally framed on its side by a current collecting plate comprising a connection terminal for the current and by an end clamping plate that is rigid in order to be able to axially tighten the stack of cells while distributing the pressure over the surface of the cells.

Electrical insulation can be interposed between these two plates in the case in which the clamping plate is conductive in order to insulate it from the collecting plate.

It was then determined during cold starts of the fuel cell that if the temperature of the central cells rise relatively quickly by self-heating, the temperature of the cells of each end rise distinctly less rapidly because the collecting plate, that is metallic, forms a thermal mass that absorbs the heat energy generated by the electrochemical reactions.

Therefore, during cold starts of the fuel cell, the temperatures among the plates are not very uniform and there is a more significant risk of the water freezing that is produced at the ends of the cell stack.

In order to remedy this problem a known type of collecting plate presented in particular in the document US-A1-2004/0161659 comprises a series of holes made perpendicularly to the plate in order to reduce the quantity of material and the thermal mass of this collecting plate.

One problem that is posed with this type of collecting plate is that a distribution of the temperature on this plate is then obtained, in particular, on the surface of the plate in contact with the last cell that is not uniform, since the temperature can be elevated at the level of the holes and remains low between these holes.

Furthermore, the current is not collected at the level of the holes, which brings about a poor distribution of the density of the current and a lowering of the performances.

### SUMMARY

The present invention has the particular goal of avoiding these disadvantages of the prior art and of proposing a collecting plate comprising a reduced thermal mass, which permits an advantageous distribution of temperature.

To this end a current collecting plate for a fuel cell is disclosed which comprises a substantially constant thickness of an electrically conductive material along the axis of the cells of this stack, forming a plane that extends to the end of this stack for collecting the current of the fuel cell, characterized in that it comprises holes made in the thickness of the material parallel to the plane of this plate.

One advantage of this current collecting plate is that the holes in the thickness define areas empty of material, reducing the thermal mass of the collecting plate while preserving a face in contact with the last cell that remains continuous, and maintains the uniformity of the temperature of this cell.

The collecting plate in accordance with the invention can furthermore comprise one or more of the following characteristics that can be combined with each other.

The holes are advantageously parallel with each other.

The holes advantageously traverse the plate through its entire thickness.

The current collecting plate advantageously comprises at least ten parallel holes.

According to one embodiment the holes comprise a basically constant rectangular section.

The constant rectangular section of the holes advantageously comprises, in accordance with the thickness of the plate, a height representing approximately 30 to 40% of this thickness and the width of these holes is basically equal to the distance between two holes.

In particular, the current collecting plate can comprise a stack with the thickness of several elements, certain elements comprising recesses in the form of conduits on their surface that constitute the holes after being superpositioned.

In particular, the current collecting plate can comprise a central connection terminal forming an axis perpendicular to this plate.

Also disclosed is a process for dimensioning holes of a collecting plate, comprising any one of the previous characteristics, in which, for a fuel cell delivering a given current density, for example, of 1 A/cm², the volume of material withdrawn from this plate is maximized by calculating a maximum admissible voltage drop, for example of 0.1 V, between the connection terminal of this plate and any point on the plate at a distance from this terminal.

It is contemplated that a fuel cell can be comprised of a stack of cells comprising a current collecting plate on both sides, which collecting plates comprise any one of the previous characteristics.

Furthermore, it is contemplated that an electric vehicle comprising a fuel cell delivering an electric current for traction, and an electricity-generating group comprising a fuel cell delivering an electric current, can be comprised of cells, which cells comprise the previous characteristic.

### DESCRIPTION OF THE FIGURES

The invention will be better understood and other characteristics and advantages will appear more clearly from a reading of the following description given by way of example with reference made to the attached drawings in which:

FIG. 1 is a view of an end of the stack of a fuel cell;

FIG. 2 is a perspective view of a collecting plate in accordance with the prior art;

FIG. 3 is a graph showing a cross-sectional view of this prior art collecting plate equipped with its clamping plate, and the distribution of temperature during a cold starting;

FIG. 4 is another graph showing this distribution of temperature;

FIG. 5 is a perspective view of a collecting plate in accordance with the claimed invention;

FIG. 6 is a graph showing a cross-sectional view of the collecting plate of FIG. 5 equipped with its clamping plate, and the distribution of temperature during a cold starting; and

FIG. 7 is another graph showing this the distribution of temperature.

### DETAILED DESCRIPTION

FIG. 1 shows an end of the stack of a fuel cell 2 comprising a succession of cells each comprising a set 4 of two electrodes separated by an electrolyte, framed by collecting plates 6 called “bipolar,” that conduct the electric current from one cell to the other while adding the reactants necessary for the electrochemical reactions to these cells.

The last conductive plate 6, that is monopolar, receives an end collecting plate 8 comprising a central connection terminal 10 forming a perpendicular axis that is connected to an outside electrical conductor for transmitting the current generated by the fuel cell 2.

The connection terminal 10 traverses a thick and rigid insulating clamping plate 12 made of an electrically insulating material such as plastic material or of a metal covered with an insulation that is subjected to an axial tightening for tightening the stack of cells.

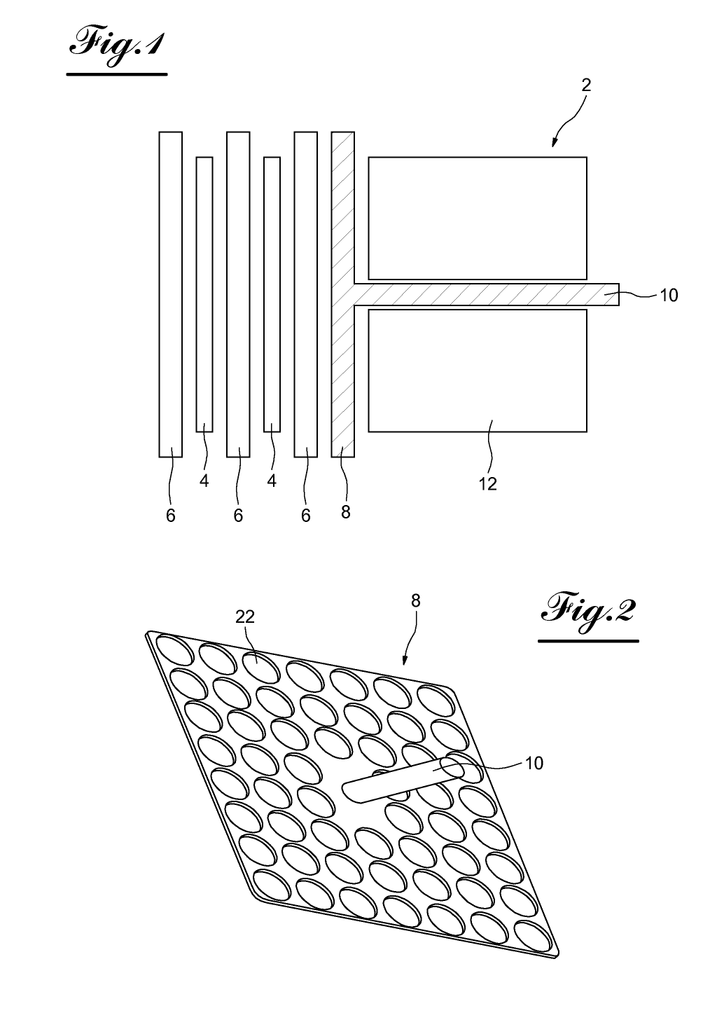

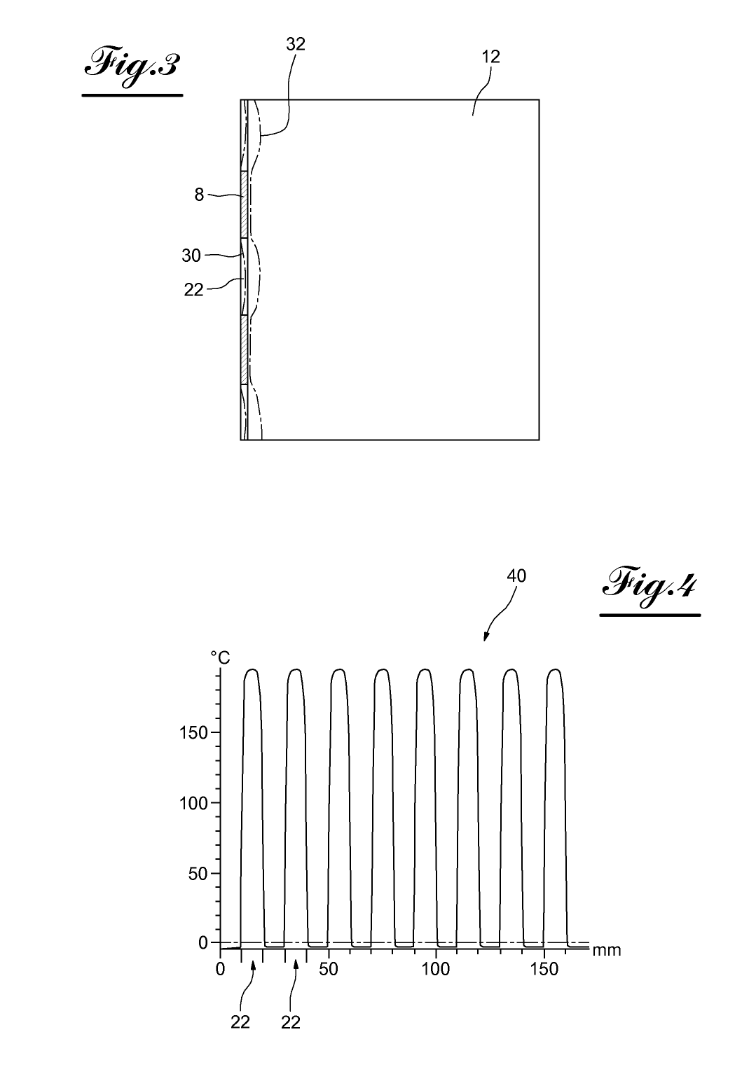

FIG. 2 is a detail of the collecting plate 8 made of an electrically conductive metal forming a basically square plane with a constant thickness and comprising holes 22 on its surface distributed regularly over parallel rows.

The connection terminal 10 forms an axis implanted in the middle of the collecting plate 8 in a zone that does not have a hole 22. The collecting plate 8 collects the electrical current globally on the entire surface of the last monopolar plate 6 in order to transmit it via its connection terminal 10.

FIG. 3 shows a partial cross-section of the collecting plate 8 equipped with its clamping plate 12 made of a polymer, on which a simulation of a distribution of temperature was carried out. The partial section is made in a zone remote from the edges of the collecting plate 8 in order to avoid edge effects, which edges are cooled by natural convection with the ambient air present at a temperature of −20° C.

The last cell, not shown and located on the left side of the collecting plate 8 is considered as being a constant and homogeneous heat source. The fuel cell 2 started after 20 seconds starting from a temperature of −20° C.

Two lines of isotemperature were traced on the section, a first line 30 at approximately 100° C. and a second line 32 at approximately 0° C. It is noted that the hollows of the holes 22 are at a temperature greater than 100° C. while almost the entire collecting plate 8 as well as the clamping plate 12 remain cold with an initial temperature of −20° C.

It can be deduced from this that, as a result of thermal conduction due to the contact between the collecting plate 8 and the last cell that was placed side by side with it, a substantially similar distribution of temperature will be obtained on this cell. The holes 22 containing air constitute an insulation in practice that maintains an elevated temperature on the facing part of the cell whereas the material of the collecting plate 8 constitutes a heat sink between these holes that absorbs the thermal energy emitted by this cell.

FIG. 4 represents in another manner this unequal distribution of the temperature. The graph 40 shows, on its x-axis, the distance in mm measured on the contact plane of the collecting plate 8 with the last cell, following the cross-section, and, on its y-axis, the temperature of this plane. It is noted that the holes 22 are located in hot zones that can reach 200° C. whereas between the holes the temperature remains below 0° C.

FIG. 5 shows a collecting plate 50 in accordance with the claimed invention in detail, comprising in its thickness of 1 mm a succession of parallel holes 52 in the plane of this plate with a constant rectangular section that are arranged parallel with each other and pass through the plate from one side to the other.

The rectangular section of the holes 52 comprises, following the thickness of the collecting plate 50, a height equal to one third of the thickness or approximately 0.3 to 0.4 mm, which is centered at the middle of this plate. The rectangular section also comprises a width of 7 mm, which is substantially equal to the distance between two of these holes. This yields a reduction of the material of the collecting plate 50 and therefore of its mass and of its thermal capacity without braking the passage of the current in a noticeable manner. “Thermal capacity of the plate” denotes the quantity of heat that can be stored for a given volume of the plate.

The collecting plate 50 also comprises a central connection terminal 10, that is not shown and that is similar to the one presented in the prior art.

The volume of the holes 52 is advantageously greater that 10% of the total volume of the plate in order to obtain a substantial reduction of the thermal capacity of the collecting plate 50. The holes 52 are designed in such a manner as to obtain a sufficiently homogenous collecting plate 50 with a good distribution of the electric current as well as of the temperature. For this, in practice at least ten holes are made in the collecting plate 50.

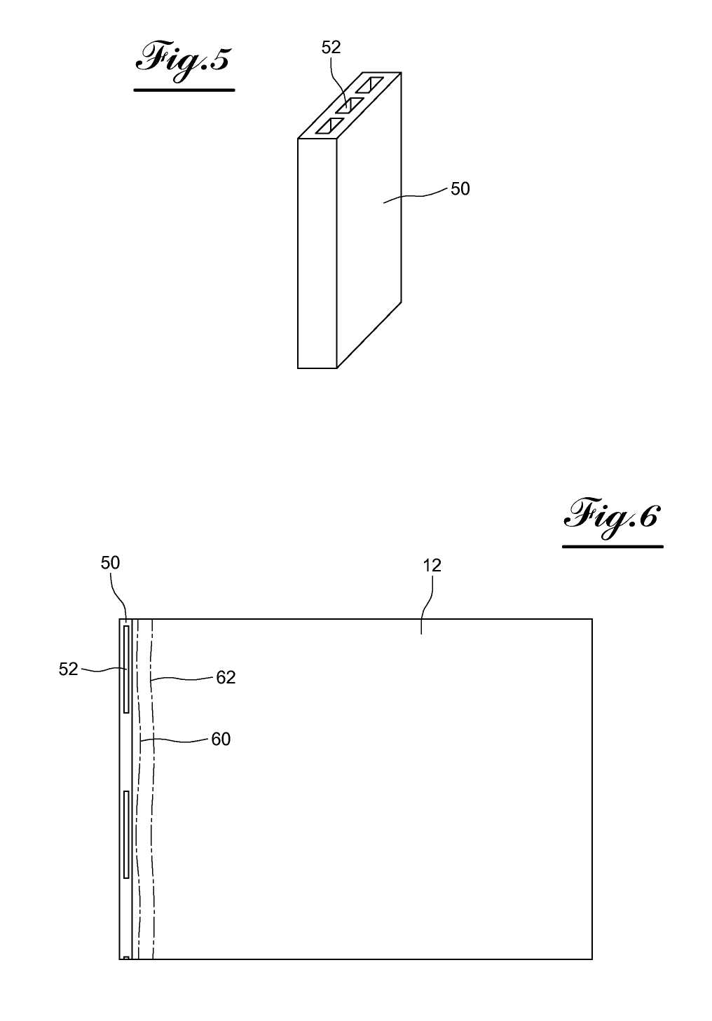

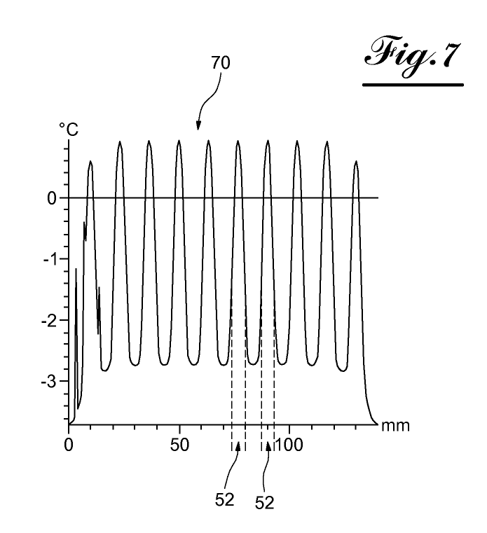

FIG. 6 shows a cross-section of the collecting plate 50 equipped with its clamping plate 12 made of polymer. The section is made in a plane transverse to the holes 52 and a simulation of the distribution of the temperature was made under conditions equivalent to those presented above.

The fuel cell 2 started after 20 seconds, starting from an initial temperature of −20° C. Two isotemperature lines were traced on the section, a first line 60 at approximately −10° C. and a second line 62 at approximately −18° C.

It is noted that the temperature is distributed in a basically constant manner as regards the holes 52 as well as between these holes. In particular, the left face of the collecting plate 50, in contact with the last cell, has a basically constant temperature. This last cell then has a thermal performance that is relatively uniform on its entire surface, which allows the obtaining of a uniform functioning and yield of the complete cell.

Therefore, this can achieve a relatively uniform temperature rise of the collecting plate 50 as well as of the last cell adjacent to it, avoiding cold points remaining below 0° C.

FIG. 7 shows this distribution of temperature on the contact plane of the collecting plate 50 with the last cell in another manner in graph 70. Graph 70 shows, along its x-axis, the distance in mm measured on the contact plane of the collecting plate 8 with the last cell along the transversal section, and, along its y-axis, the temperature of this plane.

It is noted that the holes 52 are located in zones that are a little hotter and which can reach about 1° C., whereas between the holes the temperature is approximately −3° C., which represents a slight separation of temperature.

The collecting plate 50 can advantageously be manufactured by stacking with a thickness of several elements. In particular, a plate with a thin and constant thickness can be superposed on another plate comprising on its surface parallel recesses in the form of conduits constituting, after superpositioning, the holes 52 in such a manner as to readily realize these holes.

As a variant, different types of holes 52 can be formed in the thickness of the collecting plate 50. In particular, the holes 52 can comprise different sections, for example, circular, and their distributions can be varied.

In the design of the holes 52 a compromise is to be made between the reduction of the thermal capacity of the collecting plate 50 and the increase of the electrical resistance of this plate due to the shrinkage of the conducting metal in these holes.

Moreover, the design of the collecting plate 50 is made to obtain a satisfactory mechanical hold of the unit.

In practice, a satisfactory compromise was found for a fuel cell delivering a current density of 1 A/cm² by making holes 52 providing for the nominal temperature range, for example, between 20 and 80° C. for a fuel cell with a solid polymeric electrolyte and in particular between 60 and 80° C. for vehicle applications, a voltage drop between the connection terminal 10 and any point at a distance from this terminal, which is at the maximum 0.1V.

In this case, for example, for a fuel cell delivering a total voltage of 50V the loss for the two end collecting plates 50 is at the maximum 0.2V for the most remote points, which represents less than 0.4% of the total voltage.

This calculation can be advantageously made with a numeric 3D model based on the method of finite elements (using, for example, software such as Comsol Multiphysics or FreeFem), which simulates the electrical conduction in materials with stationary conditions by applying a condition to the current density limits of 1A/cm² on the face in contact with the monopolar plate and by applying a condition to the limits of 0V on the external surface of the connection terminal.

For this simulation a grid of the collecting plate 50 was made by varying the number of holes 52, their section and the placement of these holes in order to maximize the volume of material withdrawn while limiting the voltage drop at all points, for example, to a ceiling of 0.1V. The examples of holes indicated above were made with this simulation method.

The fuel cell in accordance with the invention can advantageously serve for an automobile vehicle but also for all stationary applications such as an electricity-generating group in which a rapid temperature rise is sought.

1. A current collecting plate for a fuel cell, comprising an conductive material having substantially constant thickness along an axis of a stack of cells, the collecting plate forming a plane that extends to the end of this stack for collecting current of the fuel cell, wherein the collecting plate comprises holes made in the thickness of the material which extend parallel to the plane of this plate.

2. The current collecting plate according to claim 1, wherein the holes are parallel with each other.

3. The current collecting plate according to claim 1, wherein the holes extend through the plate from one side to another side.

4. The current collecting plate according to claim 3, wherein the collecting plate comprises at least ten parallel holes.

5. The current collecting plate according to claim 1, wherein the holes comprise a basically constant rectangular section.

6. The current collecting plate according to claim 5, wherein the constant rectangular section of the holes comprises, in accordance with the thickness of the plate, a height representing approximately 30 to 40% of this thickness and that the width of these holes is basically equal to the distance between two adjacent holes.

7. The current collecting plate according to claim 1, wherein the collecting plate comprises a stack of plates, and wherein at least one of the plates of the stack of plates defines at least one channel on a surface of said at least one of the plates; said channel defining the holes when the plates of the stack of plates are formed into the stack of plates.

8. The current collecting plate according to claim 1, wherein the collecting plate comprises a central connection terminal forming an axis perpendicular to the plate.

9. A process for dimensioning the holes of the collecting plate, made according to claim 1, wherein, for a fuel cell delivering a determined current density, the volume of material withdrawn from this plate is maximized by calculating a determined maximum admissible voltage drop, between the connection terminal of this plate and any point on the plate spaced from the terminal.

10. A fuel cell comprising a stack of cells comprising a current collecting plate on both sides, wherein the collecting plates are made according to claim 1.

11. An electric vehicle comprising a fuel cell delivering an electric current used for traction, wherein the fuel cell is made according to claim 10.

12. An electricity-generating group comprising a fuel cell delivering an electric current, wherein the fuel cell is made according to claim 10.

13. The process of claim 9 wherein the current density is 1 A/cm² and maximum voltage drop is 0.1V.
